(19) United States
(12) Patent Application Publication
(10) Pub. No.: US 2021/0131394 A1
(43) Pub. Date: May 6, 2021

(54) DIRECT INJECTION ASSEMBLY FOR A DUAL INJECTION SYSTEM OF A MOTOR VEHICLE

(71) Applicant: GM Global Technology Operations LLC, Detroit, MI (US)

(72) Inventor: Andrew G Balding, Wixom, MI (US)

(21) Appl. No.: 16/671,917

(22) Filed: Nov. 1, 2019

(51) Int. Cl. F02M 69/04; F02M 59/02; F02M 59/10; F02M 59/46

(52) U.S. Cl. CPC F02M 69/046; F02M 59/025; F02M 59/46; F02M 59/105; F02M 59/102

(57) ABSTRACT

A direct injection assembly includes a follower mechanism having an input piston operably engaged with a camshaft and moving between first and second input positions along a first follower axis, in response to the camshaft rotating about a camshaft axis. The follower mechanism further includes an output piston movable between first and second output positions along a second follower axis. The follower mechanism further includes a coupler mechanism movable between a deactivated state and an activated state where the coupler mechanism holds the input piston and the output piston in fixed positions relative to one another, such that the coupler mechanism transmits a force from the input piston to the output piston. A pump includes a plunger movable from a first plunger position to a second plunger position where the plunger pressurizes the volume of fuel, in response to the plunger receiving the force from the output piston.

### INTRODUCTION

The present disclosure relates to fuel injection systems for motor vehicles, and more particularly, to a dual injection system including multiple port injection assemblies and direct injection assemblies including a fuel pump and a follower mechanism that mitigates pump losses and increases the life cycle of the pump.

Automotive manufacturers are continuously developing fuel injection systems for increasing fuel flexibility, improving engine performance, and reducing engine-out emissions. Examples of fuel injection include port injection (PI) and direct injection (DI).

PI systems can include fuel injectors for injecting fuel into the intake manifold, such that the air fuel mixture is drawn into the engine cylinder when the intake valve opens. Because the fuel absorbs heat when it is transitions from liquid to gas, the fuel cools down the intake air before it reaches the combustion chamber. The decrease in temperature of the intake air increases its density and allows more fuel to added so as to increase the power of the engine. Because the injectors are disposed upstream of the intake ports away from the valves and spark plugs, there is ample time for the fuel to fully vaporize before it reaches the engine cylinder.

DI systems can include fuel injectors for injecting fuel directly into the engine cylinder instead of injecting fuel into the intake manifold upstream of the engine cylinder. As compared to PI systems, DI systems improve combustion efficiency, increase fuel economy, and reduce emissions. However, small particles of oil and dirt can blow back from the crankcase ventilation system and deposit onto the walls of the intake port and the back of the valve. Carbon can adhere to the valve because fuel does not spray down the back of the valves as it does in a PI system. The buildup can become significant enough that carbon deposits can break off and damage the catalytic converter or cause ignition problems. DI systems may also experience low-speed pre-ignition (LSPI), which is an abnormal combustion event caused by higher cylinder pressures common in turbocharged DI engines running in low-speed, high-torque conditions.

Dual injection systems can include both PI fuel injectors for delivering fuel to associated intake ports at a first pressure and DI fuel injectors driven by a camshaft for delivering fuel at a second pressure higher than the first pressure. When the dual injection system uses only the PI fuel injectors to deliver fuel to the engine, the camshaft continues to drive the DI fuel injectors, which are moved to a full bypass mode to recirculate fuel without delivering any to the engine. This continued operation of the DI injectors can reduce the life cycle of the DI fuel injectors, cause pump losses, and reduce the fuel economy of the vehicle.

Thus, while DI fuel system arrangement of motor vehicles achieve their intended purpose, there is a need for a new and improved DI fuel system arrangement that addresses these issues.

### SUMMARY

According to several aspects of the present disclosure, a direct injection assembly is provided for use with a camshaft to pressurize a volume of fuel for an internal combustion engine of a motor vehicle. The assembly includes a follower mechanism having an input piston operably engaged with the camshaft and moving between first and second input positions along a first follower axis, in response to the camshaft rotating about a camshaft axis. The follower mechanism further includes an output piston movable between first and second output positions along a second follower axis. The follower mechanism further includes a coupler mechanism movable between a deactivated state and an activated state where the coupler mechanism holds the input piston and the output piston in fixed positions relative to one another while moving along a corresponding one of the first and second follower axes for transmitting, using the coupler mechanism, a force from the input piston to the output piston. The assembly further includes a pump having a plunger engaged with the output piston of the follower mechanism and movable from a first plunger position to a second plunger position where the plunger pressurizes the volume of fuel, in response to the plunger receiving the force from the output piston of the follower mechanism.

In one aspect, the input and output pistons move along a respective one of the first and second follower axes, in response to the coupler mechanism being disposed in the activated state while the camshaft is rotating about the camshaft axis.

In another aspect, the input piston moves along the first follower axis and the output piston remains in a fixed position along the second follower axis, in response to the coupler mechanism being disposed in the deactivated state and the camshaft rotating about the camshaft axis.

In another aspect, the coupler mechanism is a hydraulic lost motion device including a body defining a hydraulic chamber with the input and output pistons disposed at least partially within the hydraulic chamber. The follower mechanism further includes a working fluid disposed within the hydraulic chamber. In addition, the follower mechanism also includes a variable-bleed valve in fluid communication with the hydraulic chamber and an outlet channel, wherein the variable-bleed valve is configured to selectively vary a bleed rate between the hydraulic chamber and the outlet channel. The variable-bleed valve and the input and output pistons are in fluid communication with the working fluid in the hydraulic chamber, such that displacement of the input piston into the hydraulic chamber causes a proportional displacement of the output piston, and the proportional displacement of the output piston is dependent on the bleed rate.

In another aspect, the follower mechanism further includes a roller follower configured to follow motion of the camshaft, with the input piston being spring-biased to follow motion of the roller follower. The follower mechanism further includes a finger carrying the roller follower, wherein the finger pivots about a first end and further includes a second end configured to transfer motion of the finger to the input piston. The roller follower is disposed between the first end and the second end, such that the motion of the cam is proportionally transferred to the input piston.

In another aspect, the assembly further includes a lash adjuster pivotably attached to the first end of the finger.

In another aspect, the lash adjuster is a mechanical lash adjuster.

According to several aspects of the present disclosure, a dual fuel injection system is provided for use with a camshaft to pressurize a volume of fuel for an internal combustion engine of a motor vehicle. The system includes a camshaft for rotating about a camshaft axis, a port injection assembly for delivering a first volume of fuel to a first pressure, and a direct injection assembly for delivering a second volume of fuel to a second pressure that is above the first pressure. The direct injection system includes a follower mechanism. The follower mechanism includes an input piston operably engaged with the camshaft and moving between first and second input positions along a first follower axis, in response to the camshaft rotating about a camshaft axis. The follower mechanism includes an output piston movable between first and second output positions along a second follower axis. The follower mechanism includes a coupler mechanism movable between a deactivated state and an activated state where the coupler mechanism holds the input piston and the output piston in fixed positions relative to one another while moving along a corresponding one of the first and second follower axes for transmitting, using the coupler mechanism, a force from the input piston to the output piston. The direct injection assembly further includes a pump having a plunger engaged with the output piston of the follower mechanism and movable from a first plunger position to a second plunger position where the plunger pressurizes the volume of fuel, in response to the plunger receiving the force from the output piston of the follower mechanism. The system further includes a controller coupled to the direct injection assembly and configured to move the coupler mechanism to the activated state where the direct injection assembly pressurizes the second volume of fuel to the second pressure, and the controller is further coupled to the port injection assembly and configured to actuate the port injection assembly to pressurize the first volume of fuel to the first pressure.

In one aspect, the input and output pistons move along a respective one of the first and second follower axes, in response to the coupler mechanism being disposed in the activated state while the camshaft is rotating about the camshaft axis.

In another aspect, the input piston moves along the first follower axis and the output piston remains in a fixed position along the second follower axis, in response to the coupler mechanism being disposed in the deactivated state and the camshaft rotating about the camshaft axis.

In another aspect, the coupler mechanism is a hydraulic lost motion device including a body defining a hydraulic chamber with the input and output pistons disposed at least partially within the hydraulic chamber. The follower mechanism further includes a working fluid disposed within the hydraulic chamber. In addition, the follower mechanism also includes a variable-bleed valve in fluid communication with the hydraulic chamber and an outlet channel, wherein the variable-bleed valve is configured to selectively vary a bleed rate between the hydraulic chamber and the outlet channel. The variable-bleed valve and the input and output pistons are in fluid communication with the working fluid in the hydraulic chamber, such that displacement of the input piston into the hydraulic chamber causes a proportional displacement of the output piston, and the proportional displacement of the output piston is dependent on the bleed rate.

In another aspect, the follower mechanism further includes a roller follower configured to follow motion of the camshaft. The follower mechanism further includes a finger carrying the roller follower, wherein the finger pivots about a first end and further includes a second end configured to transfer motion of the finger to the input piston. The follower mechanism further includes a spring for biasing the input piston against the second end of the finger to follow motion of the roller follower. The roller follower is disposed between the first end and the second end, such that the motion of the cam is proportionally transferred to the input piston.

In another aspect, the assembly further includes a lash adjuster pivotably attached to the first end of the finger.

In another aspect, the lash adjuster is a mechanical lash adjuster.

According to several aspects of the present disclosure, a method for operating a direct injection assembly, with the direct injection assembly including a camshaft, a pump, a controller, and a follower mechanism having input and output pistons and a coupler mechanism. The method includes rotating the camshaft about a camshaft axis. The input piston of the follower mechanism moves between the first and second input positions along a first follower axis, in response to the camshaft rotating about a camshaft axis. The coupler mechanism moves between deactivated and activated states. The coupler mechanism holds the input piston and the output piston in fixed positions relative to one another, in response to the coupler mechanism being disposed in the activated state. The coupler mechanism transmits a force from the input piston to the output piston, in response to the input and output pistons being held in fixed positions relative to one another. The output piston moves between first and second output positions along a second follower axis, in response to the coupler mechanism being disposed in the activated state while the camshaft is rotating about the camshaft axis. A plunger of the pump moves from a first plunger position to a second plunger position where the plunger pressurizes a first volume of fuel, in response to the output piston moving from the first output position to the second output position.

In one aspect, the method further includes disposing the output piston in one fixed position along the second follower axis, in response to the coupler mechanism being disposed in the deactivated position while the camshaft is rotating about the camshaft axis.

In another aspect, the method further includes defining, within a body, a hydraulic chamber with the input and output pistons disposed at least partially within the hydraulic chamber. A working fluid is disposed within the working fluid, and a variable-bleed valve is used to fluidly communicate the hydraulic chamber and an outlet channel with one another. The variable-bleed valve selectively varies a bleed rate between the hydraulic chamber and the outlet channel. The method further includes displacing the input piston of the follower mechanism and displacing the output piston of the follower mechanism in proportion to displacement of the input piston and the bleed rate.

In another aspect, the method further includes a roller follower following the motion of the camshaft such that the input piston follows the motion of the roller follower.

In another aspect, the method further includes a finger carrying the roller follower; and a first end of the finger transferring the motion of the finger to the input piston.

In another aspect, the method further includes the roller follower proportionally transfers the motion of the camshaft to the input piston.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 is a schematic view of a motor vehicle having a propulsion system including a dual fuel injection system with multiple direct injection assemblies and port injection assemblies.

FIG. 2 is an enlarged cross-sectional view of a portion of the dual fuel injection system of FIG. 1, illustrating one of the direct injection assemblies and one of the port injection assemblies for an associated one of the engine cylinders.

FIG. 3 is an enlarged cross-sectional view of the direct injection assembly of FIG. 2, illustrating the direct injection assembly having a pump with a plunger in a first plunger position.

FIG. 4 is an enlarged cross-sectional view of the direct injection assembly of FIG. 3, illustrating the direct injection assembly having a follower mechanism with a coupler mechanism disposed in a deactivated state for holding the plunger in the first plunger position.

FIG. 5 is an enlarged cross-sectional view of the direct injection assembly of FIG. 3, illustrating the coupler mechanism disposed in an activated state for moving the plunger to a second plunger position.

FIG. 6 is an enlarged cross-sectional view of another example of a direct injection assembly, illustrating a coupler mechanism in the form of a hydraulic lost motion device with a plunger of a pump in a first plunger position.

FIG. 7 is an enlarged cross-sectional view of the direct injection assembly of FIG. 6, illustrating the hydraulic lost motion device having a variable bleed valve disposed in a deactivated state for bleeding a working fluid at a bleed valve rate such that the plunger remains in the first plunger position while the camshaft is rotating.

FIG. 8 is an enlarged cross-sectional view of the direct injection assembly of FIG. 7, illustrating the variable bleed valve disposed in an activated state for moving the plunger to a second plunger position while the camshaft is rotating.

FIG. 9 is a flow chart of a method for operating the dual fuel injection system of FIGS. 6-8.

### DETAILED DESCRIPTION

The following description is merely exemplary in nature and is not intended to limit the present disclosure, application, or uses.

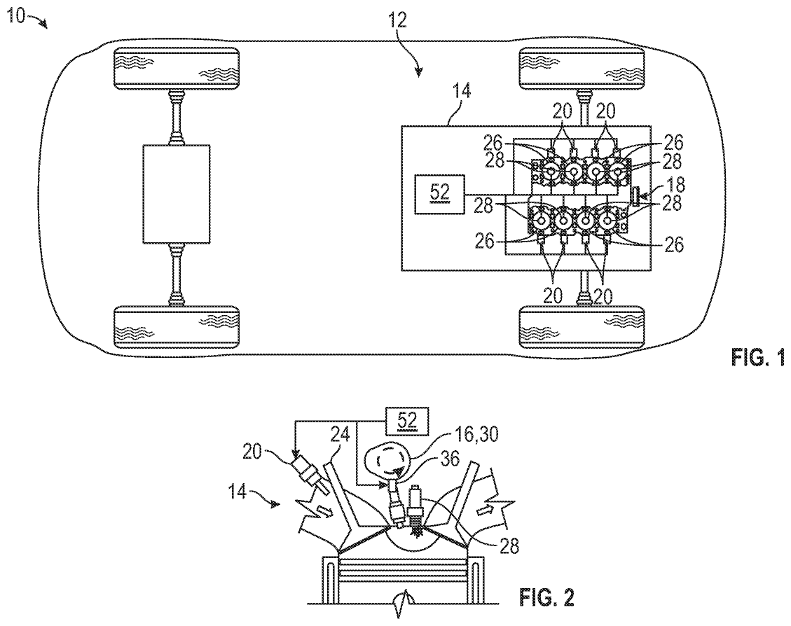

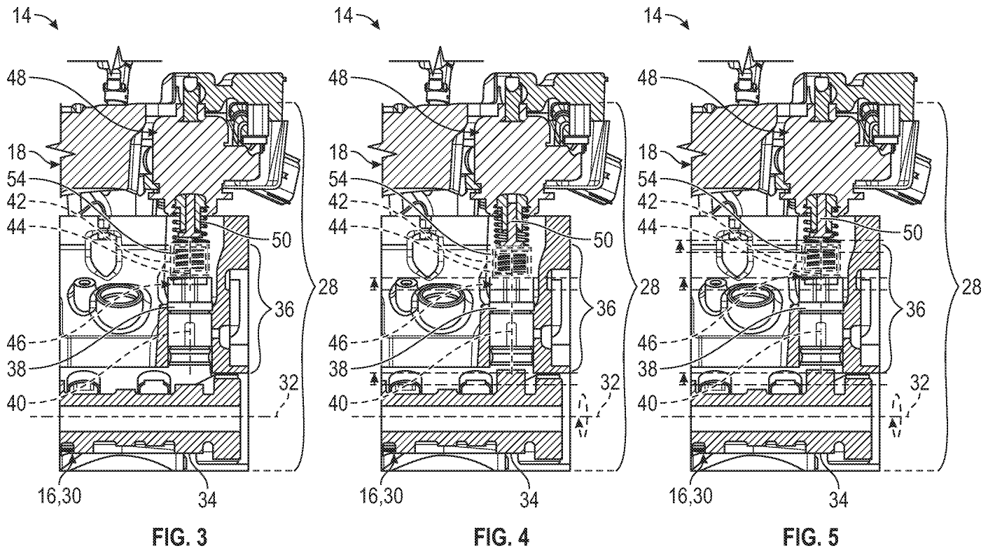

Referring to FIGS. 1 and 2, there is generally illustrated a motor vehicle 10 having a propulsion system 12 including a dual injection system 14 for use with a camshaft 16 (FIGS. 3-5) to pressurize a volume of fuel for an internal combustion engine 18 of the motor vehicle 10. The dual injection system 14 include a plurality of port injection assemblies 20 fluidly communicating with an intake manifold 22 upstream of an associated intake valve 24 and engine cylinder 26 for delivering a first volume of fuel to a first pressure. The dual injection system 14 further includes a plurality of direct injection assemblies 28 fluidly communicating directly with an associated engine cylinder 26 for delivering a second volume of fuel to a second pressure that is higher than the first pressure. It is contemplated that the dual injection system 14 can be selectively actuated for operating only the port injection assemblies 20, only the direct injection assemblies 28, or a combination of both the port injection assemblies 20 and the direct injection assemblies 28.

Referring to FIGS. 3-5, the dual injection system 14 further includes an actuator 30 for operating one or more of the direct injection assemblies and port injection assemblies. In this example, the actuator 30 is a camshaft 16 coupled to and driven by a crankshaft (not shown) for rotating about a camshaft axis 32. The camshaft 16 has a plurality of cam lobes 34, with one of the cam lobes 34 illustrated in FIGS. 3-5.

Each direct injection assembly 28 includes a follower mechanism 36 having an input piston 38 operably engaged with the actuator 30. Continuing with the previous example, the actuator 30 is the camshaft 16, and the input piston 38 is operably engaged with the camshaft 16. The input piston 38 is movable between a first input position (FIG. 3) and a second input position (FIGS. 4 and 5) along a first follower axis 40, in response to the camshaft 16 rotating about the camshaft axis 32. The follower mechanism 36 further includes an output piston 42 movable between a first output position (FIGS. 3 and 4) and a second output position (FIG. 5) along a second follower axis 44. The follower mechanism 36 further includes a coupler mechanism 46 movable between a deactivated state (FIGS. 3 and 4) and an activated state (FIG. 5). In response to the coupler mechanism 46 being disposed in the deactivated state and the camshaft 16 rotating about the camshaft axis 32, the input piston 38 moves along the first follower axis 40 and the output piston 42 remains in a fixed position along the second follower axis 44. In response to the coupler mechanism 46 being disposed in the activated state and the camshaft 16 rotating about the camshaft axis 32, the coupler mechanism 46 holds the input and output pistons 38, 42 in fixed positions relative to one another while moving along a corresponding one of the first and second follower axes 40, 44 for transmitting a force from the input piston 38 to the output piston 42.

The direct injection assembly 28 further includes a pump 48 having a plunger 50 configured to engage the output piston 42 of the follower mechanism 36. The plunger 50 is movable from a first plunger position (FIGS. 3 and 4) to a second plunger position (FIG. 5) where the plunger 50 pressurizes the volume of fuel, in response to the plunger 50 receiving the force from the output piston 42 of the follower mechanism 36.

Referring back to FIG. 1, the dual injection system 14 further includes a controller 52 electrically coupled to the direct injection assemblies 28. The controller 52 is configured to move the coupler mechanism 46 to the activated state (FIG. 5) where the direct injection assembly 28 pressurizes the second volume of fuel to the second pressure. The controller 52 is further electrically coupled to the port injection assemblies 20 and configured to actuate the port injection assemblies 20 to pressurize the first volume of fuel to the first pressure. Each direct injection assembly 28 further includes a biasing member 54 for moving the coupler mechanism 46 to the deactivated state.

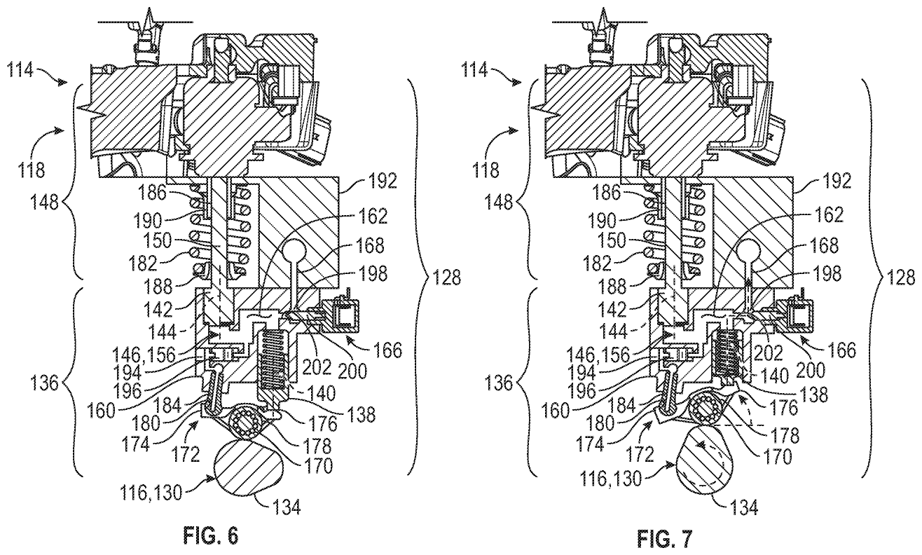

Referring to FIGS. 6-8, another example of a direct injection assembly 128 including a coupler mechanism 146 is similar to the direct injection assembly 28 of FIGS. 3-5 and has similar components referenced by the same numbers increased by 100. As described in greater detail below, the coupler mechanism 146 is a hydraulic lost motion device 156, which includes a hydraulic linkage 158 having a body 160 that defines a hydraulic chamber 162. The input and output pistons 138, 142 are disposed at least partially within the hydraulic chamber 162, such that the hydraulic chamber 162 fluidly communicates with the input and output pistons 138, 142. The follower mechanism 136 further includes a working fluid 164, such as engine oil, which has low compressibility and is disposed within the hydraulic chamber 162. As described in detail below, rotation of camshaft 116 causes a fixed volume of the working fluid 164 to be displaced, every cycle, by the input piston 138. The follower mechanism 136 further includes a variable-bleed valve 166, which fluidly communicates with the hydraulic chamber 162 and an outlet channel 166. The variable-bleed valve 166 is configured to selectively vary a bleed rate between the hydraulic chamber 162 and the outlet channel 166. The input and output pistons 138, 142 are operably connected to one another by the working fluid 164 in the hydraulic chamber 162, such that displacement of the input piston 138 into the hydraulic chamber causes a proportional displacement of the output piston 142, and the proportional displacement of the output piston 142 is dependent on the bleed rate.

More specifically, in this example, the follower mechanism 136 further includes a roller follower 170 engaging the cam lobe 134 and configured to receive a linear force, in response to the camshaft 116 rotating about the camshaft axis 132. The roller follower 170 maintains contact with camshaft 116 without relative motion between the contact surfaces to avoid the associated sliding friction losses.

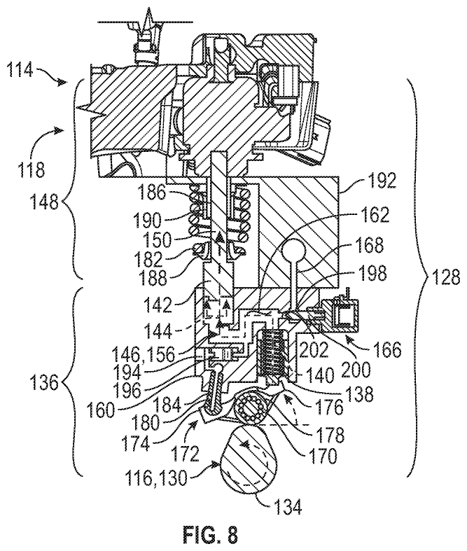

The follower mechanism 136 further includes a finger 172 rotatably carrying the roller follower 170. The finger 172 includes first and second ends 174, 176 with a center portion 178 therebetween. The finger 172 is disposed at the center portion 178 between the first and second ends 174, 176 such that the motion of the camshaft 116 is proportionally transferred to the input piston 138. The finger 172 pivots about the first end 174, which in this example takes the form of a hemi-spherical socket 180. The second end 176 of the finger 172 is configured to transfer motion of the finger 172 to the input piston 138. The second end 176 has a defined radius of curvature and contacts the tip of the input piston 138. As the camshaft 116 rotates, the input piston 138 is driven in a reciprocating linear motion by the finger 172 against a spring 182, which maintains contact between the input piston 138 and second end 176 of the finger 172. With each rotation of the camshaft 116, the roller follower 170 moves from riding on the base circle portion (FIG. 6), during which no axial displacement is transferred to the input piston 138, to riding on the lift profile portion (FIGS. 7 and 8), during which the finger 172 causes the input piston 138 to rise and fall. In other examples, it is contemplated that the camshaft 116 can act directly on a flat surface on top of the finger, which means that the contact surfaces between the camshaft and finger are moving relative to each other. In still other examples, the camshaft can act directly on the input piston.

The follower mechanism 136 further includes a lash adjuster 184 pivotably attached to the hemi-spherical socket 180 of the finger 172. In this example, the lash adjuster 184 is a mechanical lash adjuster, with lash compensation for closing any gaps in fixed cam-follower-to-pump connections. These gaps are designed expansion joints and are normally closed by thermal expansion as the engine heats up. Without some form of lash compensation, there may be gaps between the moving elements of the direct injection assembly, especially while the engine is cold, which may result in increased noise or wear. Furthermore, wear of components of the assembly may cause gaps over time. A hydraulic lash adjuster is a mechanism which closes gaps during both cold and hot operating conditions by using pressurized fluid to move the lash compensator into contact with the follower element, regardless of engine and fuel injection system temperature. The mechanical lash adjuster 184 is a support element that provides mechanical lash compensation. An initial adjustment, usually at the time of assembly of the direct injection assembly 128, is made to contact the mechanical lash adjuster 184 to the first end 174 of the finger 172.

As shown in FIG. 8, the input piston 138 acts through the hydraulic linkage 158 for transmitting a linear force to the output piston 142 and driving the same in a reciprocating linear motion, in response to the hydraulic linkage 158 being disposed in the activated state while the camshaft 116 rotates about the camshaft axis 132. More specifically, the output piston 142 acts on the plunger 150, including a plunger guide 186, a plunger biasing spring 182, a spring cap 188 and retainers 190. The plunger 150 and the plunger guide 186 are carried in a block 192. The output piston 142 is positioned co-axially with the plunger 150 along the second follower axis 144, and it imparts its linear motion to the plunger 150. Those having ordinary skill in the art will recognize that, while only one plunger 150 is shown in FIG. 1, the output piston 142 could act on multiple plungers for associated fuel pumps.

While the first and second follower axes 140, 144 are spaced apart from one another, it is contemplated that the first and second follower axes 140, 144 may be collinear such that the input piston and the plunger may be movable along a common axis. In addition, it is contemplated that the first and second follower axes may be angularly spaced from one another such that the plunger is movable along the second follower axis that is angularly spaced from the first follower axis of the input piston. Those having ordinary skill in the art will recognize that the tip geometry of the input piston 138 may be comparable to the tip of a plunger used in conventional engines not having a hydraulic linkage.

Displacement by input piston 138 results in hydraulic pressure generation in the chamber 162. If the chamber 162 is otherwise closed—such that the volume of fluid 164 within the chamber 162 remains essentially constant without substantial leakage—and the working fluid 164 is substantially incompressible, the output piston 142 will be displaced by an equal volume. If the input and output pistons 138, 142 have substantially equal diameter (a hydraulic diameter ratio of 1:1), the axial displacement of the input piston 138 results in a substantially equal axial displacement of the output piston 142, thereby displacing the plunger 150 by the same distance.

A checked supply line 194 connects the chamber 162 to a hydraulic pressure source, such as the oil pump (not shown), and permits flow into the hydraulic linkage 158 when the pressure inside the hydraulic linkage 158 falls below the supply pressure. A check valve 196 located on the supply line 194 prevents backflow towards the pressure source when the pressure inside of hydraulic linkage 158 is above the supply pressure.

The variable-bleed valve includes a variable-bleed orifice 198 configured to selectively vary the bleed rate of fluid 164 from the chamber 162. In this example, the variable-bleed orifice 198 includes a flow control valve 200 configured to selectively vary the size of a drain port 202 in fluid communication with the chamber 162. The variable-bleed orifice 198 connects the fluid 164 to a drain 202, which may connect to an oil sump (not shown) or a pressure accumulator (not shown). The flow control valve 200 is shown for exemplary purposes only. Those having ordinary skill in the art will recognize numerous types of valves, or combinations of valves, that may be used within variable-bleed orifice 198 to selectively control the bleed rate of fluid 164 from chamber 162. Furthermore, it is contemplated that neither the variable-bleed orifice 198 nor the drain 202 have to be located in the either the block 192. The variable-bleed orifice 198 need only be in fluid communication with chamber 162 and the drain 202. Furthermore, the drain 202 may feed the pressurized fluid 164 escaping chamber 162 into an accumulator which supplies downstream components with pressurized fluid instead of re-pressurizing fluid for those components directly with a pump. Furthermore, the accumulator could also return the bled volume of fluid 164 back to the hydraulic chamber 162 during the base-circle event (during which the chamber 162 is re-pressurized).

The proportion of the displaced volume of working fluid 164 converted into motion of the output piston 142 is dependent on the bleed rate through the variable-bleed orifice 198 to the drain port. The principle of volume continuity requires that the sum of the bled volume and the volume swept by the output piston 142 equals the volume displaced by the input piston 138—neglecting any leakage and fluid compressibility effects.

Referring to FIG. 7, in response to the coupling mechanism 146 being disposed in the deactivated state, the flow control valve 200 is set to provide the largest variable-bleed orifice 198 opening, the displaced input volume could equal the bled volume. At this operating condition, all motion of the input piston 138 is lost in the hydraulic linkage 158, and the output piston 142 and the plunger 150 remain stationary. This total lost-motion condition may be used to hold the plunger in a fixed position and completely deactivate the fuel pump or may be used to limit movement of the plunger 150 and modulate the volume of fuel pressurized and deliver by the fuel pump 148.

Referring to FIG. 8, in response to the coupling mechanism 146 being disposed in the activated state, the flow control valve 200 seals the drain port 202, enabling the transfer of the entire input motion through the hydraulic linkage 158 to the output piston 142 and the plunger 150. This zero lost-motion condition directly transfers lift of the camshaft 116 to the plunger 150 as if the hydraulic linkage 158 were a mechanical linkage. For any intermediate setting of the variable-bleed orifice 198 by the flow control valve 200, displacement is proportionally transferred from the input piston 138 to the output piston 142, and different plunger 150 lift profiles are achieved, from no lift (pump deactivation due to total lost-motion) to full lift (relative to the lift profile of the camshaft 116).

In other embodiments, the linear displacement of the input and output pistons 138, 142 may not be exactly equal even where the variable-bleed orifice 198 has completely closed the drain port 202 for the zero lost-motion condition. Leakage of fluid 164 from the chamber 162 will reduce the displaced volume transferred to outlet piston 142, and compression of the (non-ideal) fluid 164 may also reduce the displacement of outlet piston 142. Furthermore, it is contemplated that, even in a perfectly sealed chamber 162 filled with an incompressible fluid Y, displacement of the output piston 142 is dependent upon the hydraulic diameter ratio of the input and output pistons 138, 142. Matching linear displacement of the plunger 150 (through the output piston 142) to the axial displacement of input piston 138 (through linear displacement by the camshaft 116), dictates a 1:1 ratio of hydraulic diameters.

Where the input and output pistons 138, 142 are not equal in diameter, the linear displacement ratio is inversely related to the hydraulic diameter ratio. The linear displacement ratio of the input piston 138 over the output piston 142 is equal to the ratio of the area of output piston 142 over the area of input piston 138 (if there is no lost motion). For example, where the hydraulic diameter ratio (input:output diameter) is 2:1, the output piston 142 will have four times the linear displacement of the input piston 138 (the input:output linear displacement ratio will be 1:4). A configuration having a smaller output piston 142 allows a relatively smaller camshaft 116, because displacement of the input piston 138 is multiplied through the hydraulic linkage 158 to result in larger displacement of the plunger 150.

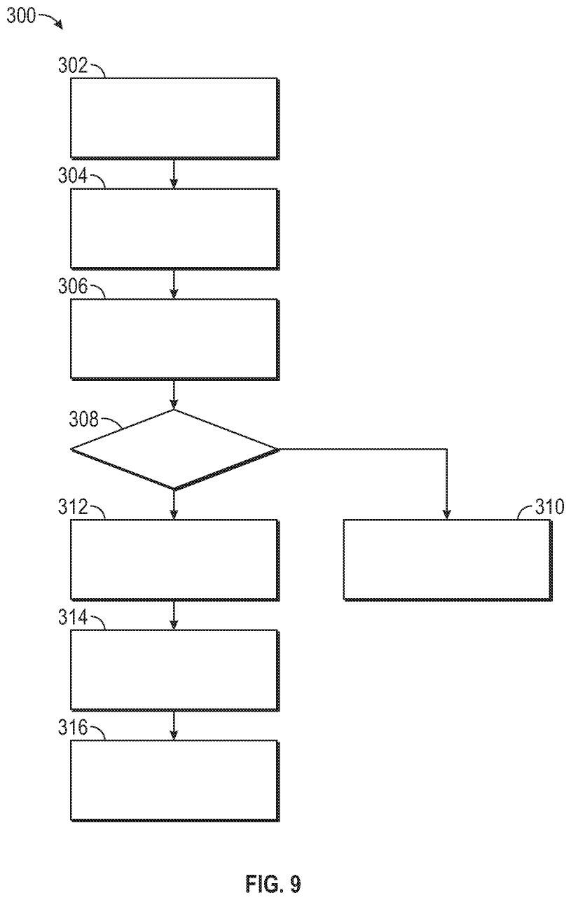

Referring now to FIG. 9, a flow chart for a method 300 for operating the direct injection assembly 128 of FIGS. 6-8 is illustrated. The method 300 commences with the step 302 of providing power to an actuator 130 for actuating the direct injection assembly 128. In this example, the camshaft 116 is driven by a crankshaft for rotating about the camshaft axis 132. It is contemplated that other suitable actuators may be used for actuating the direct injection assembly 128.

At step 304, the input piston 138 of the follower mechanism 136 moves between the first and second input positions along the first follower axis 40, in response to the camshaft 116 rotating about a camshaft axis 132. In this example, the cam lobe 134 transmits a linear force to the roller follower 170, such that the roller follower 170 follows the motion of the camshaft 116, and the input piston 138 follows the oscillatory motion of the roller follower. More specifically, the finger 172 carries the roller follower 170, and the finger 172 pivots about its first end 174 with the second end 176 transmitting the linear force to the input piston 138, in response to the roller follower 170 receiving the linear force from the cam lobe 134. The roller follower 170 proportionally transfers the motion of the camshaft 116 to the input piston 138, in response to for example the location of the roller follower on the finger 172 between the first and second ends of the finger 172. In other examples, the cam lobe can transmit the linear force directly to the finger. In still other examples, the cam lobe can transmit he linear force directly to the input piston.

At step 306, the controller 152 determines the volume of fuel to be pressurized by the direct injection assembly 128. In one example, the controller 152 can determine that the direct injection assembly 128 will deliver none of the fuel to be delivered to the engine. As but one non-limiting example, the controller can determine that the direct injection assembly 128 will deliver none of the fuel to the engine and the port injection assembly 120 will deliver all the fuel to the engine, in response to the controller 152 determining that the engine speed is below a predetermined speed threshold and the engine torque is below a predetermined torque threshold. However, it is contemplated that the controller can determine that the direct injection assembly 128 will deliver any volume of fuel to the engine in response to other vehicle condition.

At step 308, the controller 152 determines whether it will actuate the coupler mechanism 146 to move between deactivated and activated states, in response to the controller determining the volume of fuel to be pressurized by the direct injection assembly 128. If the controller 152 determines that that it will actuate the coupler mechanism 146 to move to the deactivated state, the method proceeds to step 310. If the controller 152 determines that that it will actuate the coupler mechanism 146 to move to the activated state, the method proceeds to step 312.

At step 310, the output piston 142 remains disposed in one fixed position along the second follower axis 144, in response to the coupler mechanism 146 being disposed in the deactivated position while the camshaft 116 is rotating about the camshaft axis 132. Continuing with the previous example, the controller 152 actuates the coupler mechanism 146 to move to the deactivated state in response to the controller determining that the direct injection assembly will deliver none of the fuel to the engine. Because the output piston remains in one fixed position, the friction losses can be mitigated, and the associated fuel economy of the vehicle can be improved.

At step 312, the controller actuates the coupler mechanism to move to the activated state in response to the controller determining that the direct injection assembly will deliver at least a portion of the fuel to the engine. The coupler mechanism 146 holds the input piston 138 and the output piston 142 in fixed positions relative to one another, in response to the controller actuating the coupler mechanism 146 to be disposed in the activated state. The coupler mechanism 146 transmits a force from the input piston 138 to the output piston 142, in response to the input and output pistons 138, 142 being held in fixed positions relative to one another.

In this example, the coupling mechanism 146 is the hydraulic lost motion device 156, which includes the hydraulic linkage 158 having the variable-bleed valve 166 fluidly communicating with the hydraulic chamber 162 and the outlet channel 166. The variable-bleed valve 166 selectively varies the bleed rate between the hydraulic chamber 162 and the outlet channel 166, such that the bleed rate inversely corresponds with the volume of fuel to be pressurized and delivered by the direct injection assembly. The body 160 defines the hydraulic chamber 162 containing the working fluid, and the input and output pistons 138, 142 are disposed at least partially within the hydraulic chamber 162.

At step 314, the output piston 142 moves between first and second output positions along the second follower axis 144, in response to the coupler mechanism 146 being disposed in the activated state while the camshaft 116 is rotating about the camshaft axis 132. Continuing with the previous example, the output piston 142 of the follower mechanism 136 is displaced in direct proportion to displacement of the input piston 138 and inversely proportion to the bleed rate.

At step 316, the plunger 150 of the pump 148 moves from the first plunger position to the second plunger position where the plunger 150 pressurizes the first volume of fuel, in response to the output piston 142 moving from the first output position to the second output position.

The description of the present disclosure is merely exemplary in nature and variations that do not depart from the general sense of the present disclosure are intended to be within the scope of the present disclosure. Such variations are not to be regarded as a departure from the spirit and scope of the present disclosure.

1. A direct injection assembly for use with a camshaft to pressurize a volume of fuel for an internal combustion engine of a motor vehicle, the direct injection fuel system comprising:
a follower comprising:
an input piston operably engaged with the camshaft and moving between first and second input positions along a first follower axis, in response to the camshaft rotating about a camshaft axis;
an output piston movable between first and second output positions along a second follower axis, with the first and second follower axes being spaced laterally apart from one another, and the input and output pistons do not overlap one another along a vertical direction that is parallel to the first and second follower axes; and
a coupler movable between a deactivated state and an activated state where the coupler holds the input piston and the output piston in fixed positions relative to one another while moving along a corresponding one of the first and second follower axes for transmitting, using the coupler, a force from the input piston to the output piston; and
a pump having a plunger engaged with the output piston of the follower and movable from a first plunger position to a second plunger position where the plunger pressurizes the volume of fuel, in response to the plunger receiving the force from the output piston of the follower.

2. The direct injection assembly of claim 1 wherein the input and output pistons move along a respective one of the first and second follower axes, in response to the coupler being disposed in the activated state while the camshaft is rotating about the camshaft axis.

3. The direct injection assembly of claim 2 wherein the input piston moves along the first follower axis and the output piston remains in a fixed position along the second follower axis, in response to the coupler being disposed in the deactivated state and the camshaft rotating about the camshaft axis.

4. The direct injection assembly of claim 3 wherein the coupler is a hydraulic lost motion device comprising:
a body defining a hydraulic chamber with the input and output pistons disposed at least partially within the hydraulic chamber;
a working fluid disposed within the hydraulic chamber; and
a variable-bleed valve in fluid communication with the hydraulic chamber and an outlet channel, wherein the variable-bleed valve is configured to selectively vary a bleed rate between the hydraulic chamber and the outlet channel;
wherein the variable-bleed valve and the input and output pistons are in fluid communication with the working fluid in the hydraulic chamber, such that displacement of the input piston into the hydraulic chamber causes a proportional displacement of the output piston, and the proportional displacement of the output piston is dependent on the bleed rate.

5. The direct injection assembly of claim 4 wherein the follower further comprises:
a roller follower configured to follow motion of the camshaft;
a finger carrying the roller follower, wherein the finger pivots about a first end and further includes a second end configured to transfer motion of the finger to the input piston; and
a spring for biasing the input piston against the second end of the finger to follow motion of the roller follower;
wherein the roller follower is disposed between the first end and the second end, such that the motion of the cam is proportionally transferred to the input piston.

6. The direct injection assembly of claim 5 further comprising a lash adjuster pivotably attached to the first end of the finger.

7. The direct injection assembly of claim 6 wherein the lash adjuster is a mechanical lash adjuster.

8. A dual fuel injection system for pressurizing a volume of fuel for an internal combustion engine of a motor vehicle, the dual fuel injection system comprising:
a camshaft for rotating about a camshaft axis;
a port injection assembly for delivering a first volume of fuel at a first pressure; and
a direct injection assembly for delivering a second volume of fuel at a second pressure that is above the first pressure, wherein the direct injection assembly comprises:
a follower comprising:
an input piston operably engaged with the camshaft and moving between first and second input positions along a first follower axis, in response to the camshaft rotating about the camshaft axis;
an output piston movable between first and second output positions along a second follower axis, with the first and second follower axes being spaced laterally apart from one another, and the input and output pistons do not overlap one another along a vertical direction that is parallel to the first and second follower axes; and
a coupler movable between a deactivated state and an activated state where the coupler holds the input piston and the output piston in fixed positions relative to one another while moving along a corresponding one of the first and second follower axes for transmitting, using the coupler, a force from the input piston to the output piston; and
a pump having a plunger engaged with the output piston of the follower and movable from a first plunger position to a second plunger position where the plunger pressurizes the volume of fuel, in response to the plunger receiving the force from the output piston of the follower; and
a controller coupled to the direct injection assembly and configured to move the coupler to the activated state where the direct injection assembly pressurizes the second volume of fuel to the second pressure, and the controller is further coupled to the port injection assembly and configured to actuate the port injection assembly to pressurize the first volume of fuel to the first pressure.

9. The dual fuel injection system of claim 8 wherein the input and output pistons move along a respective one of the first and second follower axes, in response to the coupler being disposed in the activated state while the camshaft is rotating about the camshaft axis.

10. The dual fuel injection system of claim 9 wherein the input piston moves along the first follower axis and the output piston remains in a fixed position along the second follower axis, in response to the coupler being disposed in the deactivated state and the camshaft rotating about the camshaft axis.

11. The dual fuel injection system of claim 10 wherein the coupler is a hydraulic lost motion device comprising:
a body defining a hydraulic chamber with the input and output pistons disposed at least partially within the hydraulic chamber;
a working fluid disposed within the hydraulic chamber; and
a variable-bleed valve in fluid communication with the hydraulic chamber and an outlet channel, wherein the variable-bleed valve is configured to selectively vary a bleed rate between the hydraulic chamber and the outlet channel;
wherein the variable-bleed valve and the input and output pistons are in fluid communication with the working fluid in the hydraulic chamber, such that displacement of the input piston into the hydraulic chamber causes a proportional displacement of the output piston, and the proportional displacement of the output piston is dependent on the bleed rate.

12. The dual fuel injection system of claim 11 wherein the follower further comprises:
a roller follower configured to receive a linear force from the camshaft in response the camshaft rotating about the camshaft axis;
a finger carrying the roller follower, wherein the finger pivots about a first end and further includes a second end configured to transfer motion of the finger to the input piston;
a spring for biasing the input piston against the second end of the finger to follow motion of the roller follower; and
wherein the roller follower is disposed between the first end and the second end, such that the motion of the cam is proportionally transferred to the input piston.

13. The dual fuel injection system of claim 12 further comprising a lash adjuster pivotably attached to the first end of the finger.

14. The dual fuel injection system of claim 13 wherein the lash adjuster is a mechanical lash adjuster.

15. A method for operating a direct injection assembly, with the direct injection assembly including a camshaft, a pump, a controller, and a follower having input and output pistons and a coupler, the method comprising the steps of:
rotating the camshaft about a camshaft axis;
moving the input piston of the follower between first and second input positions along a first follower axis, in response to the camshaft rotating about the camshaft axis;
moving the coupler between deactivated and activated states;
holding, using the coupler, the input piston and the output piston in fixed positions relative to one another, in response to the coupler being disposed in the activated state;
transmitting, using the coupler, a force from the input piston to the output piston, in response to the input and output pistons being held in fixed positions relative to one another;
moving the output piston between first and second output positions along a second follower axis, with the first and second follower axes being spaced laterally apart from one another, such that the input and output pistons do not overlap one another along a vertical direction that is parallel to the first and second follower axes, in response to the coupler being disposed in the activated state while the camshaft is rotating about the camshaft axis;
moving a plunger of the pump from a first plunger position to a second plunger position where the plunger pressurizes a first volume of fuel, in response to the output piston moving from the first output position to the second output position.

16. The method of claim 15 further comprising disposing the output piston in one fixed position along the second follower axis, in response to the coupler being disposed in the deactivated position while the camshaft is rotating about the camshaft axis.

17. The method of claim 16 further comprising:
defining, within a body, a hydraulic chamber with the input and output pistons disposed at least partially within the hydraulic chamber;
disposing a working fluid within the hydraulic chamber;
fluidly communicating, using a variable-bleed valve, the hydraulic chamber and an outlet channel;
selectively varying a bleed rate, using the variable-bleed valve, between the hydraulic chamber and the outlet channel;
displacing the input piston of the follower; and
displacing the output piston of the follower in proportion to displacement of the input piston and the bleed rate.

18. The method of claim 17 comprising following, by a roller follower, the motion of the camshaft such that the input piston follows the motion of the roller follower.

19. The method of claim 18 further comprising:
carrying, using a finger, the roller follower; and
transferring, using a first end of the finger, the motion of the finger to the input piston.

20. The method of claim 19 further comprising proportionally transferring, using the roller follower, the motion of the camshaft to the input piston.
